(19) United States
(12) Patent Application Publication
(10) Pub. No.: US 2006/0232369 A1
(43) Pub. Date: Oct. 19, 2006

(54) Permanent magnet structure with axial access for spectroscopy applications

(75) Inventor: Mikhail V. Gorshkov, Moscow (RU)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Makrochem, Ltd., Moscow (RU)

(21) Appl. No.: 11/130,138

(22) Filed: May 17, 2005

Related U.S. Application Data
(63) Continuation-in-part of application No. 11/105,543, filed on Apr. 14, 2005.

(51) Int. Cl. H01F 7/02

(52) U.S. Cl. 335/306

(57) ABSTRACT

A mass spectrometer with a magnet structure including a plurality of magnetic flux sources disposed along a common axis. The plurality of magnetic flux sources includes at least one permanent magnet flux source having at least one through-hole body along the common axis. The plurality of magnetic sources generates a resultant magnetic field. A direction of a magnetic field component of the resultant magnetic field along the common axis is at least once reversed along the common axis within the magnet structure.

### CROSS REFERENCE TO RELATED APPLICATIONS

This application is a continuation-in-part and claims priority under 35 U.S.C. § 120 to U.S. Ser. No. 11/105,543 filed Apr. 14, 2005 entitled “Permanent Magnet Structure with Axial Access for Spectroscopy Applications,” the entire contents of which are incorporated herein by reference.

### DESCRIPTION OF THE RELATED ART

1. Field of the Invention

The present invention relates to magnet structures and particularly to a permanent magnet structure suitable for use in mass spectrometry (MS), nuclear magnetic resonance (NMR), electron paramagnetic resonance (EPR), and magnetic resonance imaging (MRI) spectroscopies.

2. Background of the Invention

Various applications utilizing magnetic fields require fields having high strengths, i.e. high flux densities, and high homogeneity of generated magnetic fields within a space volume large enough to accommodate devices and apparatuses that perform specific tasks within the intended applications.

For example, in Fourier transform mass spectrometers (FTMS) as described in U.S. Pat. No. 3,937,955, issued Feb. 10, 1976; M. V. Buchanan, Ed. Fourier Transform Mass Spectrometry: Evolution, Innovation, and Applications, ACS Symp. Series, 1987, 359, pp. 205; A. G. Marshall, Adv. Mass Spectrom., 1989, 11A, p. 651; A. G. Marshall, L. Schweikhard, Int. J. Mass Spectrom. Ion Proc., 1992, 118/119, p. 37, the entire contents of which are incorporated herein by reference, charged particles are stored inside Penning type ion traps made of a plurality of elements. The size of those traps frequently exceeds 25 mm in all dimensions. The traps are placed inside vacuum chambers of respectively larger size and have to be freely moved in and out of a region of homogeneous high magnetic field. In particular, FTMS traps have to be located along the direction of the magnetic field lines. Since charged particles can be introduced into a strong magnetic field along the magnetic field lines, only the axial access to the ion trap region allows the introduction of ions generated in ion sources external to the ion trap region, such as electrospray ionization (ESI), matrix-assisted laser desorption/ionization (MALDI), atmospheric pressure chemical ionization (APCI), and others as described in M. Yamashita, J. B. Fenn, J. Phys. Chem., 1984, 88, p. 4451; K. Tanaka, H. Waki, Y. Ido, S. Akita, Y. Yoshida, T. Yoshida, Rapid Commun. Mass Spectrom., 1988, 2, p. 151; M. Karas, F. Hillenkamp, B. Bachmann, U. Bahr, Int. J. Mass Spectrom. Ion Proc., 1987, 78, p. 53; A. P. Bruins, Mass Spectrom. Rev., 1991, 10, p. 53, U.S. Pat. No. 5,965,884, the entire contents of which are incorporated herein by reference.

In another example, in NMR including Fourier Transform NMR spectroscopy as described in R. J. Abraham, J. Fisher, P. Loftus, Introduction to NMR Spectroscopy, Wiley, Chichester, 1988; J. W. Akitt, NMR and Chemistry: An Introduction to the Fourier Transform-Multinuclear Era, 2^{nd} ed., Chapman and Hall, London, 1983; R Freeman, A Handbook of Nuclear Magnetic Resonance, Longman Scientific and Technical, 1988, the entire contents of which are incorporated herein by reference, a probe mounted on a specially designed holder has to be easily moved in and out of the homogeneous magnetic field that again requires wide axial access, which often exceeds 25 mm in all dimensions, into a region of the high magnetic field.

Yet in another example of MRI spectroscopy as described in F. Wehrli, D. Shaw, J. B. Kneeland, Biological Magnetic Resonance Imaging: Principles, Methodology, Applications, VCH, NY, 1988, the entire contents of which are incorporated herein by reference, such applications require the use of magnetic fields generated in even larger space volume.

In order to obtain high flux densities within large space volume with wide axial access superconducting solenoids have almost exclusively been used. It is also common to employ electromagnets.

Electromagnets require large power supplies for charging and superconducting solenoids require extensive cooling systems to maintain the solenoid below the requisite critical low temperature. Liquid helium is typically used and is typically replenished periodically to cool the magnet, which makes the magnet inherently large and expensive. Not only do these attributes increase the cost of high powered electromagnets, but such approaches also diminish, if not eliminate, the portability of electromagnets due to their large size and weight, especially those capable of generating strong magnetic fields.

Permanent magnets offer an alternative magnetic flux source to electromagnets and superconducting solenoids, and do not require large power supplies or cooling systems. Nonetheless, permanent magnets in the past have been unable to generate magnetic flux densities commensurate with electromagnets. Recent advances in magnetic materials, however, have greatly increased the magnetic flux densities generated by permanent magnet systems. For example, the use of rare-earth metals such as Neodymium (Nd) and Samarium (Sm) have increased the strength of permanent magnets. The most widely used materials for permanent magnet systems are currently NdFeB and SmCo, and the variety of available magnetic materials and their properties can be found in Table of Magnetic Materials, from CRC Handbook of Chemistry and Physics, CRC Press, Inc. 1993; L. R. Moskowitz, Magnetic & Physical Properties of Permanent Magnet Materials and International Index-Cd-Rom, Krieger Pub Co; CD-Rom edition, 1998; J. M. D. Coey, J. Magn. Magn. Mater, 2002, 248, p. 241, the entire contents of which is incorporated herein by reference. Furthermore, arrangement techniques employing these materials have resulted in permanent magnets that can produce magnetic fields having flux densities above 1 T.

Employing permanent magnets in the mentioned above applications to obtain a high flux density and homogeneity of the generated magnetic field has been accomplished utilizing the U-shape permanent magnets having a yoke as described in L. R. Moskowitz, Permanent Magnet Design and Application Handbook, Krieger Publishing Company, 1995, pp. 1-961, the entire content of which is incorporated herein by reference, or by the dipolar ring magnet systems being constructed of a plurality of permanent magnets alone as was disclosed in K. Halbach, Nuclear Instruments and Methods, 1980, 189, p. 1, the entire content of which is incorporated herein by reference. However, the former structures can result in bulky magnet assemblies that require large consumption of permanent magnet material to generate uniform high magnetic field, and the latter generate a uniform high magnetic field perpendicular to the direction of the axial access inside the bore of assembly constructed from ring-shape magnets.

Therefore, utilizing any of the above two structures results in (1) limited access to the central region of the homogeneous magnetic field; (2) limited space to place a device such as charged particle trap, particle (charged or neutral) detector, or NMR probe; and (3) limited capabilities to couple a charged particle trap, or a particle detector, with the charged or neutral particle transport systems when those particles are generated outside the magnet. The latter case covers, for example, mass spectrometers with atmospheric pressure ionization sources such as ESI, MALDI, APCI, etc., or other types of mass spectrometers, such as FTMS, time-of-flight (TOF) as described in R. J. Cotter, Time-of-Flight Mass Spectrometry: Instrumentation and Applications in Biological Research, ACS Professional Reference Books, Washington, D.C., 1997, pp. 1-327; W. C. Wiley, I. H. McLaren, Rev. Sci. Instr., 1955, 26, p. 1150; A. F. Dodonov, I. V. Chernushevich, V. V. Laiko, in Time-of-Flight Mass Spectrometry, Ed. R. J. Cotter, American Chemical Society, Washington, D.C., 1994, p. 108, the entire contents of which are incorporated herein by reference.

Other mass spectrometers include radio-frequency two-dimensional (LIT, LTQ) or three-dimensional ion traps (ITMS, QIT) as described in R. E. March, R. J. Hughes, Quadrupole Storage Mass Spectrometry, John Wiley & Sons, NY, N.Y., 1989, pp. 1-471; J. C. Schwartz, M. W. Senko, J. E. P. Syka, J. Am. Soc. Mass Spectrom., 2002, 13, p. 659; J. W. Hager, Rapid Commun. Mass Spectrom., 2002, 16, p. 512; German Patent No. 944,900, U.S. Pat. Nos. 2,939,952; 3,065,640; 4,540,884; 4,882,484; 5,107,109; 5,714,755, 6,403,955 and U.S. Patent Applications Nos. 20030183759, 20050017170, the entire contents of which are incorporated herein by reference.

Other mass spectrometers include ion mobility spectrometers (IM, MMS) as described in F. W. Karasek, Anal. Chem., 1974, 46, pp. 710A-720A; G. A. Eiceman, Z. Karapas, Ion Mobility Spectrometry, Boca Raton, CRC Press, 1994, pp. 1-15; G. F. Verbeck, B. T. Ruotolo, H. A. Sawyer, K. J. Gillig, D. H. Russell, J. Biomolecular Technique, 2002, 13, p. 56, the entire contents of which are incorporated herein by reference, or combinations thereof, having external out-of-vacuum and in-vacuum generation of charged particles, which are usually transported through various differential pumping stages to the mass spectrometry analyzer.

If, for example, FTMS trap is used as a mass spectrometry analyzer that traps charged particles along the magnetic field flux direction and the direction is perpendicular to the axis along which the charged particles move from the mass spectrometry devices or particle sources outside the magnet, there are difficulties in coupling such devices or sources with the analyzer. The coupling will require an implementation of a mechanism to turn the particle beam by 90 degrees before injecting the ions into the FTMS trap that further restricts the size of the said trap and, therefore, limit the performance of the FTMS analyzer as described in M. V. Gorshkov, H. R. Udseth, G. A. Anderson, R. D. Smith, Eur. J. Mass Spectrom., 2002, 8, pp. 169-176, the entire contents of which are incorporated herein by reference.

In another example, Halbach cylinders based permanent magnet structure were employed in FTMS system as described in G. Mauclaire, J. Lemaire, P. Boissel, G. Bellec, M. Heninger, Eyr. J. Mass Spectrom., 2004, 10, pp. 155-162. In that configuration, the magnet had an axial access through a 5 cm bore into a central region with FTMS trap analyzer. The direction of the magnetic field inside the bore was perpendicular to the axis of the bore. A source of electrons to generate the ions inside the trap was mounted along the magnetic field direction thus restricting the size of the trap to 2 cm. As a consequence, the mass spectrometer performance and upper limit of mass of ions that could be trapped were limited.

### SUMMARY OF THE INVENTION

One object of present invention is to eliminate or overcome the limitations imposed on spectroscopy applications by providing homogeneous magnetic fields in large spatial volumes within magnet structures having through-holes for axial access to that working volume.

Still another object of the present invention is to provide a magnet flux source that can maximize the flux density generated per weight of magnetic material.

Still another object of the present invention is to provide axial access to the working volume along the direction of the magnetic field lines for applications in mass spectrometry, nuclear magnetic resonance spectroscopy, magnetic resonance imaging, ion mobility spectrometry, and electron paramagnetic resonance spectroscopy referred to hereafter as spectrometry.

In accordance with various of these objects, the present invention provides in one embodiment a mass spectrometer with a magnet structure including a plurality of magnetic flux sources disposed along a common axis. The plurality of magnetic flux sources includes at least one permanent magnet flux source having at least one through-hole body along the common axis. The plurality of magnetic sources generates a resultant magnetic field. A direction of a magnetic field component of the resultant magnetic field along the common axis is at least once reversed along the common axis within the magnet structure.

In various embodiments of the present invention, the plurality of magnetic flux sources can be hollow body flux sources with air bores as through-holes in the hollow body flux sources, each hollow body flux source generating a magnetic field inside the bores. The sources can be located sequentially one after another along the same axial line. The magnetic fields within the sources can be oriented in a way to generate a coherent and uniform magnetic field inside the open central region of the structure having a flux density greater than the residual flux density. The hollow body flux sources can have in general cylindrical shapes, each defined by a length along the common axis, an internal diameter of the bore, and an outside dimension of a housing of the hollow body. The axial direction can be disposed parallel to the magnetic flux lines generated inside the through-hole in the central flux source (i.e., the above-noted first flux source). The hollow body flux sources may also have other shapes such as elliptic or rectangular. The hollow body sources are permanent magnet structures that increase the flux density per weight of magnet material.

In various embodiments of the present invention, the hollow body flux sources can be made in the form of tubes with the bores (i.e., through-holes) along the common axis and having dimensions for the through-holes large enough to accommodate different types of physical devices or sample objects that can be freely moved in and out along the axis of the bores.

In various embodiments of the present invention, the magnetic field flux near the common axis along a hollow volume parallel to the common axis can permit transfer of charged electric particles (e.g., ions or electrons) from outside of the magnet structure to the central test volume inside the magnet.

In various embodiments of the present invention, the hollow body flux sources can be made of magnetic materials or incorporate magnetic materials of high magnetic properties. The hollow body sources are configured to have directions of magnetization such as to reduce magnetic flux leakage from the central regions such as to focus flux density lines into a central air gap in the first or central flux source.

In various embodiments of the present invention, a plurality of magnetic flux sources can generate a reversible magnetic field (RMF) profile inside the through-holes and along the common (i.e., longitudinal) axis. Reversible in this context means that the polarity of the magnetic flux reverses its directions along the common axis.

In various embodiments of the present invention, a plurality of magnetic flux sources can include two magnet flux sources with one magnet flux source having magnetization directed toward the common axis and the other magnet flux source having magnetization directed away from the common axis.

In various embodiments of the present invention, a plurality of magnetic flux sources can include two magnet flux sources with one magnet flux source having magnetization directed toward the common axis and the other magnet flux source having magnetization directed away from the common axis, and additional hollow body magnetic flux sources adjacent to the two magnet flux sources, placed along the same common axis with the two magnet flux sources, and that can generate a reversible magnetic field profile inside the through-holes and along the common (longitudinal) axis.

It is to be understood that both the foregoing general description of the invention and the following detailed description are exemplary, but are not restrictive of the invention.

### BRIEF DESCRIPTION OF THE DRAWINGS

A more complete appreciation of the present invention and many attendant advantages thereof will be readily obtained as the same becomes better understood by reference to the following detailed description when considered in connection with the accompanying drawings, wherein:

FIG. 1 is a schematic representation in plain view of one of the preferred embodiments of the magnet structure of the present invention;

FIG. 2A is a schematic representation in a cross-sectional view of one preferred permanent magnet structure of the present invention;

FIGS. 2B, 2C, and 2D are schematic representations showing different embodiments for holding the permanent magnetic material of the present invention;

FIGS. 3A and 3B are composite schematics comparing one preferred permanent magnet structure of the present invention in FIG. 3A to the permanent magnet structure based on Halbach cylinders in FIG. 3B;

FIG. 4A is a schematic depicting one of the alternative directions of magnetization of the magnetic materials inside a magnetic medium of the hollow body flux sources according to an embodiment of the present invention;

FIG. 4B is a schematic depicting another direction of magnetization of the magnetic materials inside a magnetic medium of the hollow body flux sources according to an embodiment of the present invention;

FIG. 5 is a schematic depicting results of the calculations of the magnetic field fluxes generated by the permanent magnet structure according to an embodiment of the present invention and a structure based on a single hollow cylinder containing magnetic materials magnetized to generate magnetic field flux along the bore axis;

FIG. 6 is a schematic depicting a profile of a magnetic field generated inside the air through-holes of the hollow body flux sources utilized in one permanent magnet structure according to an embodiment of the present invention along the common axis of the through-holes;

FIG. 7 is a schematic depicting the utilization of the magnet structure according to an embodiment of the present invention with a Fourier Transform Ion Cyclotron Resonance mass analyzer;

FIG. 8 is a schematic representation in a cross-sectional view of one preferred permanent magnet structure of the present invention utilizing only two magnet flux sources;

FIG. 9 is a schematic representation in a cross-sectional view of one preferred permanent magnet structure of the present invention utilizing four magnet flux sources with two central magnet flux sources generating an axial magnetic field along the common axis in the central working volume and two adjacent magnet flux sources generating a reversible magnetic field along the common axis; and

FIGS. 10A-10C are schematic depictions of modeling results simulating the resultant magnetic field produced by the two magnet flux sources and by the plurality of four magnet flux sources of the present invention.

### DETAILED DESCRIPTION OF THE PREFERRED EMBODIMENTS

While the invention will be described in connection with certain preferred embodiment, there is no intent to limit the present invention to those embodiments. On the contrary, all alternatives, modifications and equivalents as included within the spirit and scope of the invention are part of the present invention.

For the purpose of this invention a spectrometer can be any of mass spectrometer (MS), nuclear magnetic resonance (NMR) spectrometer, electron paramagnetic resonance (EPR) spectrometer, and magnetic resonance imaging (MRI) spectrometer, ion mobility spectrometer (IMS), or any combination thereof.

For the purpose of this invention a mass spectrometer can be any of (but not limited to) mass spectrometry of ion cyclotron resonance with or without Fourier transform to generate mass spectra, time-of-flight mass spectrometry, quadrupole mass spectrometry, and radio-frequency ion trap mass spectrometry, wherein the trap can be either three-dimensional or two-dimensional (linear); or any combination thereof.

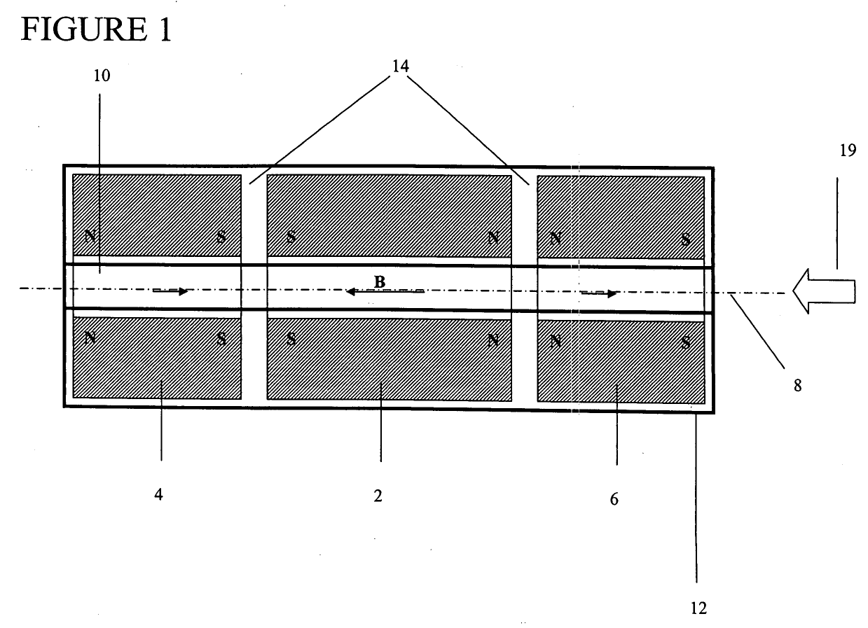

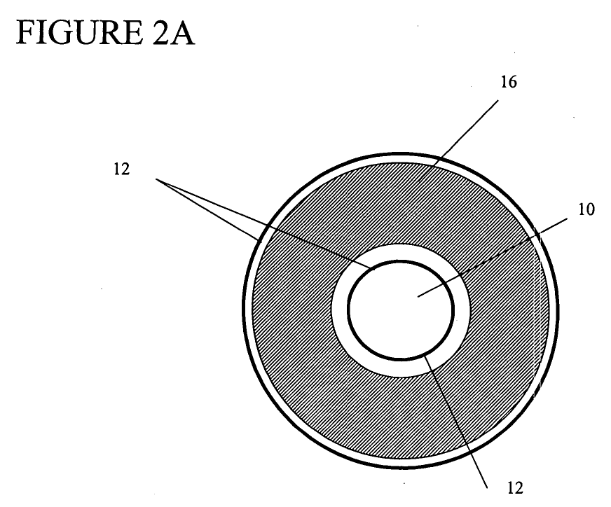

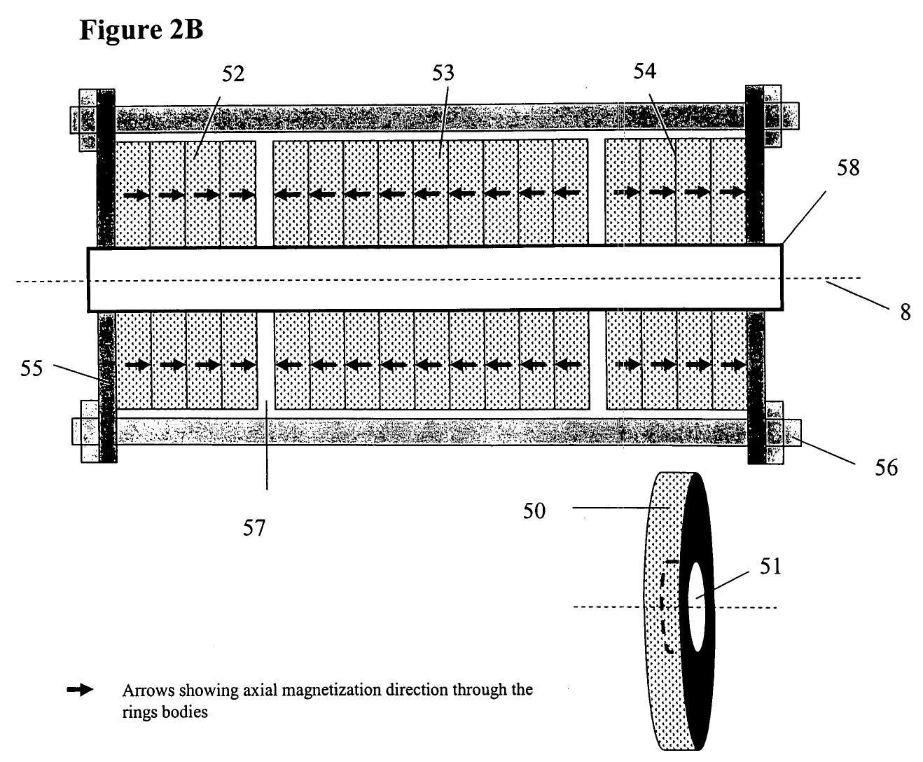

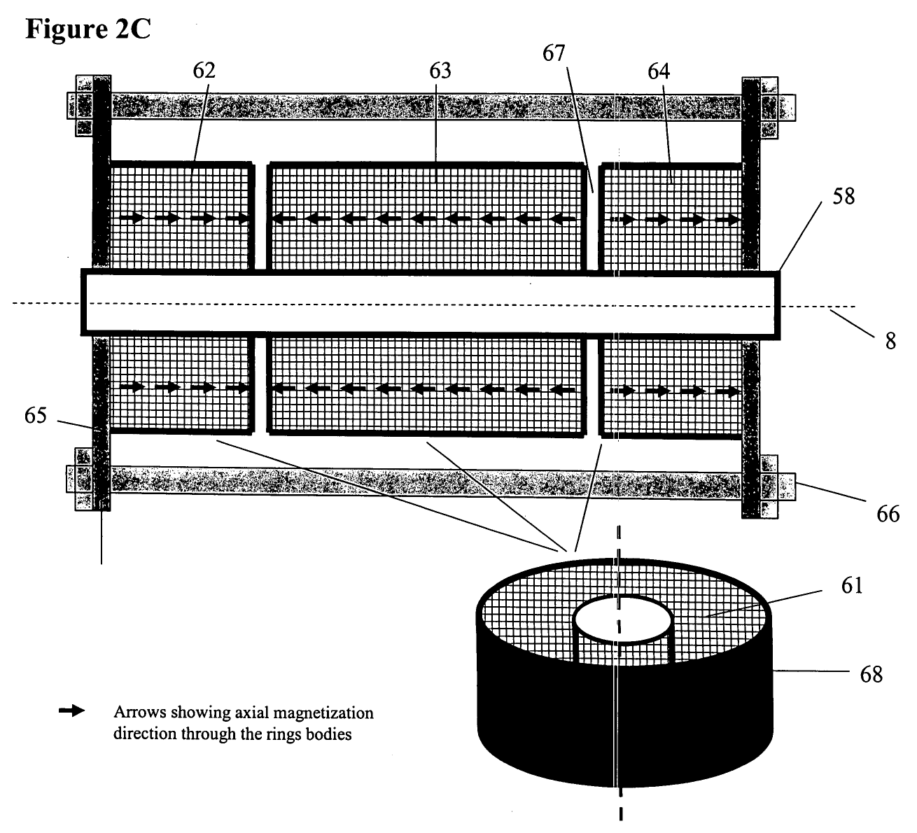

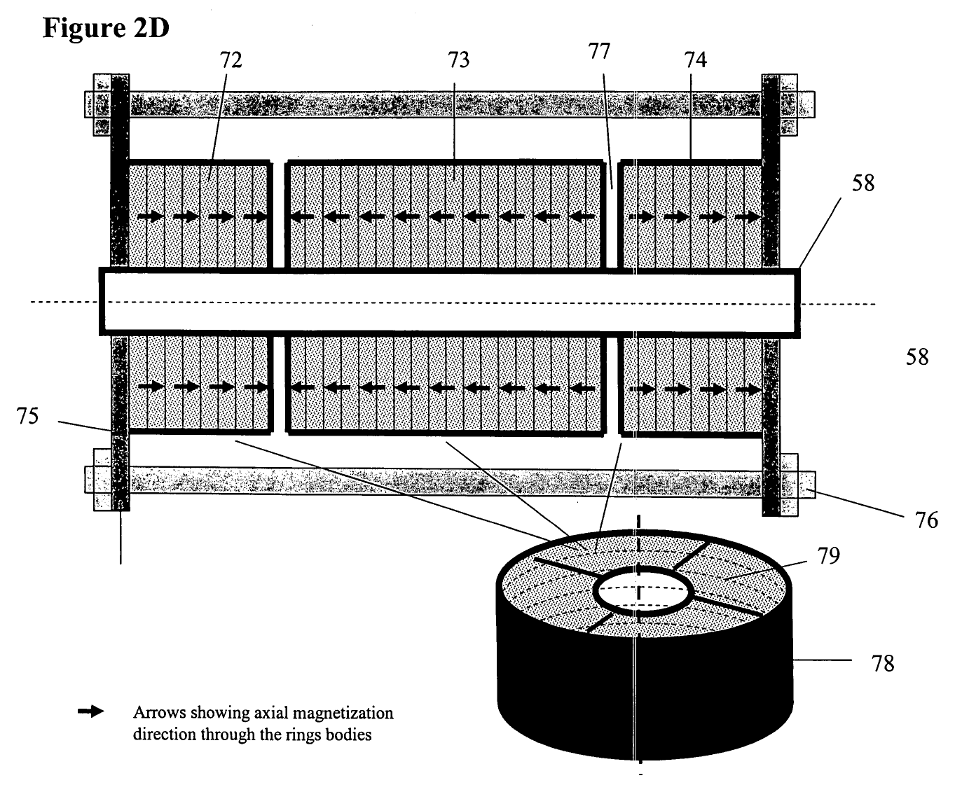

Referring now to the drawings, wherein like reference numerals designate identical, or corresponding parts throughout the several views, one preferred embodiment of the present invention, as represented in FIG. 1 and FIG. 2A, can include, as magnet flux sources 2, 4, and 6, hollow body flux sources that can have, but are not limited to, a generally cylindrical shape extending along a common axis 8. The hollow body sources can have an internal diameter defined by a through-hole 10 that extends along the common axis 8. The hollow body sources are defined by the outside surfaces of the housing 12. The magnet flux sources 2, 4, and 6 are preferably but not necessarily located aligned on the common (i.e., longitudinal axis) 8 in such a way that central axial magnetic field lines from the flux sources coincide with each other.

As such, the magnet structure of the present invention can be a set of permanent-magnet hollow body sources as shown in FIGS. 1 and 2A. having a central hollow body source 2 and adjacent hollow body sources 4 and 6, located at both ends of the central hollow body source 2 and structured in such a way that there are gaps 14 between the central hollow body source 2 and the respective adjacent hollow body sources 4 and 6.

The distance of the gap between the flux sources is varied as noted above. Distances up to 5 mm have been used. For larger magnets, this distance can be varied more. For large size magnets a gap separation distance of more than 5 mm will still produce concentration of the central flux field. In general, one can consider the gap separation to be preferably less than twice the size of the bore (or through-hole inside diameter) of the central flux source. The gap separation should preferably be as small as possible in order to generate the maximum magnetic field inside the central hollow body source.

In one preferred embodiment, as represented in FIG. 1, the gaps are variable. The magnetic field in the central hollow body source 2 is directed along the axis of the bore and is generally dipolar. The variable gaps 14 between the central hollow body source 2 and the adjacent hollow body sources 4 and 6 further provide a mechanism to adjust the homogeneity of the magnetic field in the central region of the central hollow body source 2. The homogeneity of the magnetic field in the central region can be further improved by room temperature coil shimming similar to that in superconducting solenoids, or by incorporation of additional magnetic materials inside the central region.

In a preferred embodiment, as schematically represented in FIG. 2A, ring-shaped structures 16 made of magnetic materials are incorporated inside the housing 12 made of either non magnetic, or magnetic material. The housing can be made of either a non-magnetic material, and thus has no influence on the magnetic field, or a magnetic material, and thus, having influence on magnetic field generated by sources. The housing from magnetic materials can shield the outside environment from magnetic field.

In one embodiment of the present invention, the ring shape structures 16 will be formed by using solid rings of magnetic materials that once magnetized axially would slipped into each other to form hollow cylinders of desired lengths. In general, large size rings made of high power magnetic materials may not be available, and, therefore, the rings from smaller segments and assembled to form the ring shaped structures 16 shown in FIG. 2A can be used. In this configuration, the ring shaped structure housing 12 hold the segments of magnetic material together. A variety of such constructs to hold the segments of the magnetic material together are possible according to the present invention.

Shown in FIGS. 2B, 2C, and 2D are several illustrative examples of these constructs. Basically, magnetic material in different forms (for example ring shape segments, small rectangular blocks, etc.) is packed inside the cylindrical (or elliptic, rectangular, or other shapes) through-hole cans. In case of magnetic material in the form of whole rings or cylinders, the magnetic materials need not necessary to be packed inside the cans. Before packing, the cans segments are magnetized in defined directions and packing them into cans is performed according to the magnetization direction. In other words, the packing is made such that the magnetization directions of the can segments coincide with the desired magnetization needed inside at least one of the magnet flux sources 2, 4, and 6. Alternatively (and if the sources are not too large), the cans packed with segments, and then can be magnetized thereafter with specified directions. The through-holes 10 in any of these structures while shown as cylindrical need not be perfectly cylindrical and further can be either of a cylindrical, square, elliptical shape, or other shapes.

More specifically, FIG. 2B shows a magnet structure of the present invention assembled from solid magnetic rings 50 having a central through-hole 51. As shown in FIG. 2B, three sets 52, 53, and 54 each assembled from the solid magnetic rings 50 employing the attraction between the rings 50 in each set are disposed adjacent to each other. Because of reversed magnetization between the sets 52, 53, and 54, there is strong repelling force between the sets. Two metal rings 55 connected with each other from both sides of the assembly by threaded rods 56 can prevent the sets 52, 53, and 54 from repelling, but other suitable retaining devices can be used in the present invention. In this embodiment, the rods 56 can be threaded to have the possibility to adjust gaps 57 between the sets 52, 53, and 54. Alternatively or in addition, the gaps may be filled with a non-magnetic material such as aluminum to provide additional support to the assembly. No special housing around the rings 55 is needed, but maybe useful nonetheless in this embodiment, for example, to protect the magnetic rings 50. A tube 58 (of any non-magnetic material including plastic) with outside diameter to fit the through holes and inside diameter to accommodate an inserted device or apparatus can be used.

More specifically, FIG. 2C shows a magnet structure of the present invention assembled from cylinders 62, 63, and 64 made of magnetic materials 61. Because of reversed magnetization, there is a strong repelling force between the three cylinders 62, 63, and 64. Two metal rings 65 connected with each other from both sides of the assembly by threaded rods 66 can prevent the cylinders 62, 63, and 64 from repelling, but other suitable retaining devices can be used in the present invention. In this embodiment, the rods 66 can be threaded to have the possibility to adjust gaps 67 between the cylinders 62, 63, and 64. Alternatively or in addition, the gaps may be filled with a non-magnetic material such as aluminum to provide additional support to the assembly. The cylinders can be made from a cylindrical can 68 filled with smaller size rectangular segments. Segments are made of magnetic materials and magnetized along the cylinder axis, or at the angle to the axis, the angle can be the same for all segments. The cylindrical can 68 can be covered by ring caps from both open sides. The cylindrical can 68 can be made of any non-fragile material including plastics. Segments, which fill the cylindrical cans, can be of different sizes to meet the requested size of the permanent magnet structure.

More specifically, FIG. 2D shows a permanent magnet structure of the present invention assembled from magnetized ring shape segments. As shown in FIG. 2D, three sets 72, 73, and 74 each assembled from the magnetized ring shape segments 71 are disposed adjacent to each other. Because of reversed magnetization between the sets 72, 73, and 74, there is strong repelling force between the sets. Two metal rings 75 connected with each other from both sides of the assembly by threaded rods 76 can prevent the sets 72, 73, and 74 from repelling, but other suitable retaining devices can be used in the present invention. In this embodiment, the rods 76 can be threaded to have the possibility to adjust gaps 77 between the sets 72, 73, and 74. Alternatively, the gaps may be filled with a non-magnetic material such as aluminum to provide additional support to the assembly. Each set may consist of a cylindrical can 78 that can be made of any non-fragile material including plastics and packed with ring shape segments 79. Segments 79 are made of magnetic materials and in various embodiments magnetized along the cylinder axis, or in other embodiments at the angle to the axis 8, the angle preferably but not necessarily being the same for all the segments. Segments, which fill the cylindrical cans 78, can be of different polar angle sizes. The cylindrical can 78 can be covered by ring caps from both open sides.

The housing 12 is configured to hold the magnetized materials in the ring-shaped structures 16 together to generate a predetermined magnetic field flux inside the hollow regions of the magnet flux sources 2, 4, and 6. The ring shape structures 16 can be either cylinders, or sets of rings, or sets of segments, which form an array of magnet materials having for example a cylindrical symmetry. Other suitable housing and structure geometries could be used to produce a predetermined magnetic field flux in the central region of the magnet flux sources 2, 4, and 6.

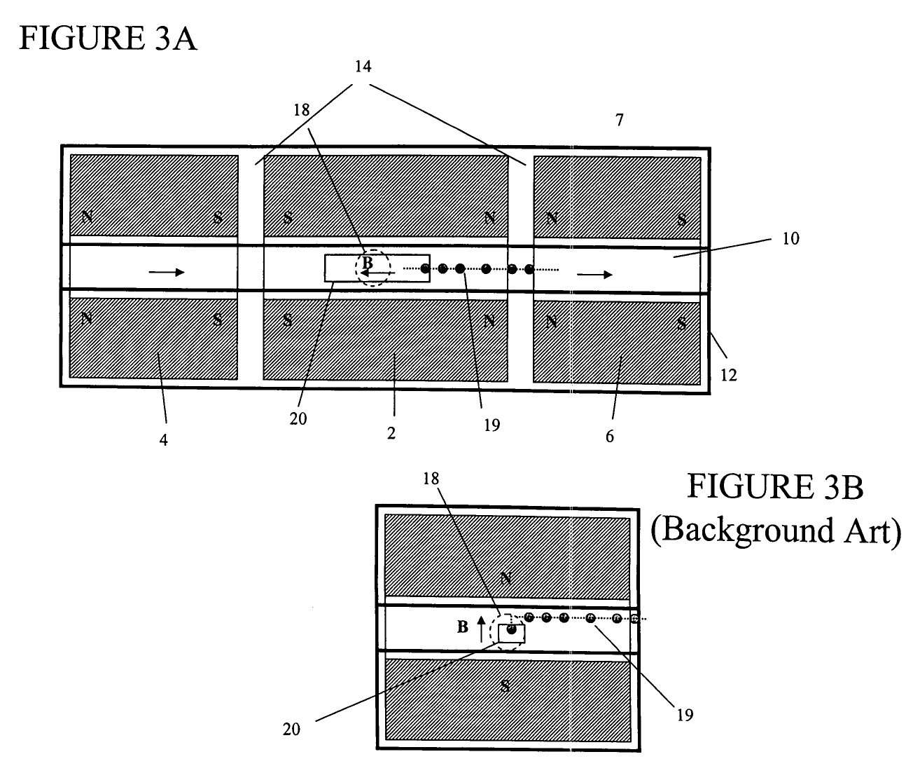

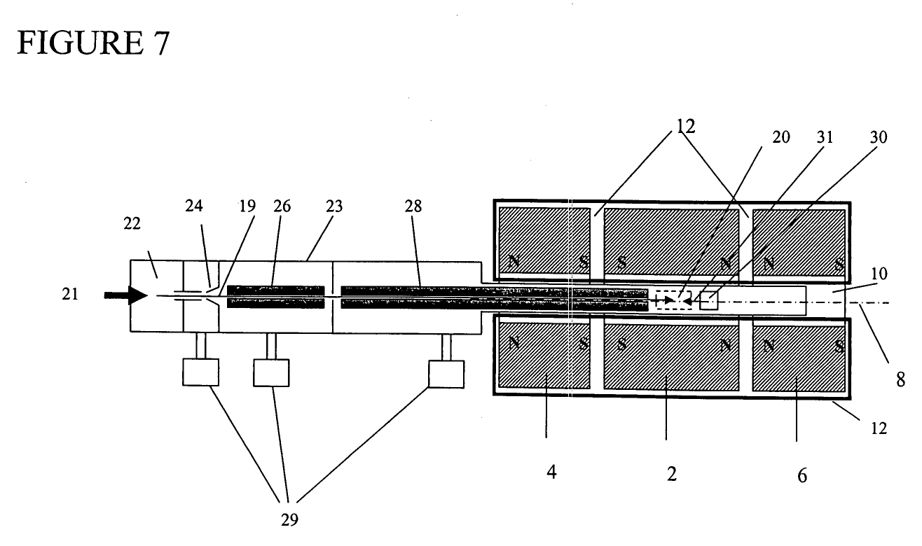

FIGS. 3A and 3B show schematically the principal difference between the directions of the dipolar magnetic field fluxes generated inside the through-holes 10 of one preferred magnet structure in FIG. 3A and the magnet structure based on Halbach cylinders in FIG. 3B employed previously in the FTMS mass spectrometry system described in G. Mauclaire, J. Lemaire, P. Boissel, G. Bellec, M. Heninger, Eyr. J. Mass Spectrom., 2004, 10, pp. 155-162, the entire contents of which are incorporated herein by reference. In the former case according to the present invention, the dipolar magnetic field flux direction in the central working volume 18 is parallel to the common axis 8, and therefore a charged particle beam 19 entering the working volume 18 along the common axis 8 from regions outside the magnet structure will be introduced directly into for example an FTMS trap 20 which is aligned along the same axis. FIG. 7 shows an illustration of the utilization of the magnet structure of the present invention with an FTMS trap. In the Halbach structure (FIG. 3B), the dipolar magnetic field flux direction in the central working volume is perpendicular to the common axis and therefore any charged particle beam incoming into the working volume along the common axis from the regions outside the magnet will have to be turned by 90 degrees before being trapped and analyzed by FTMS trap.

In general, the magnet structures of the present invention need not be exclusively permanent magnets. Indeed, the magnet structures of the present invention could use electromagnets to supplement (as in the electromagnet shims described above) or replace the permanent magnets described above. While electromagnets have some known disadvantages over permanent magnets, electromagnets offer the flexibility of elimination or modulation of the magnet flux with time in the plurality of sources in the present invention. Such electromagnets could include superconducting coils. As such, the present invention is not necessarily limited to the preferred permanent magnets described above, but rather can utilize any magnet structure to generate the opposing magnetic fields in adjacent flux sources to the central flux source in order to concentrate the central magnetic flux.

It is known for FTMS traps (e.g., Penning type traps) that the trapping is realized in two planes: (1) along the magnetic field line direction, the ions are trapped by electric field which forms a potential well along this direction; (2) in the plane perpendicular to the magnetic field line direction, the ions are trapped by a Lorentz force. Therefore, if the ions move through a working volume of a Halbach magnet, the ions move in a plane perpendicular to the magnetic field line direction, and to realize trapping by an electric field along this direction the ions have to be turned by 90 degrees before being injected into a FTMS trap. For this reason and others, existing approaches to create FTMS mass spectrometers with Halbach type magnets have had difficulty in interfacing with external ion sources. The magnet structure of the present invention addresses this problem because, in the working volume 18 of the magnet structure, ions will enter the through-hole 10 of the central flux source 2 and approach for example a FTMS trap along the magnetic field lines and therefore are trapped in a similar way as in existing FTMS mass spectrometers employing superconducting solenoid type magnets that permit coupling to external ionization sources.

Indeed, to move across magnetic lines, ions need to have high energy so that the trajectory radius is high enough for ions originating outside to reach the ICR cell located inside the Halbach type magnet. According to estimations, to have the trajectory radius r=1 m in the magnetic field B=1 T, ions need to have an energy about 100 keV, which is not practical. This is one reason why a Halbach type magnet may not be readily used in a FTICR-MS with an external ion source.

Thus, the magnet structure of the present invention does not impose any additional energy requirements on the ion source ions. Additionally, charged particles can be transported along the common axis 8 of the through-hole 10 so as not to impose any size restriction on the ion transport, unlike in the Halbach type magnet structure in which the particles have to be transported near the inner surface of the through-hole 10 before being turned by 90 degrees for trapping. Furthermore, these advantages of the magnet structure of the present invention are realized without diminution of the magnetic field strength in the working volume 18.

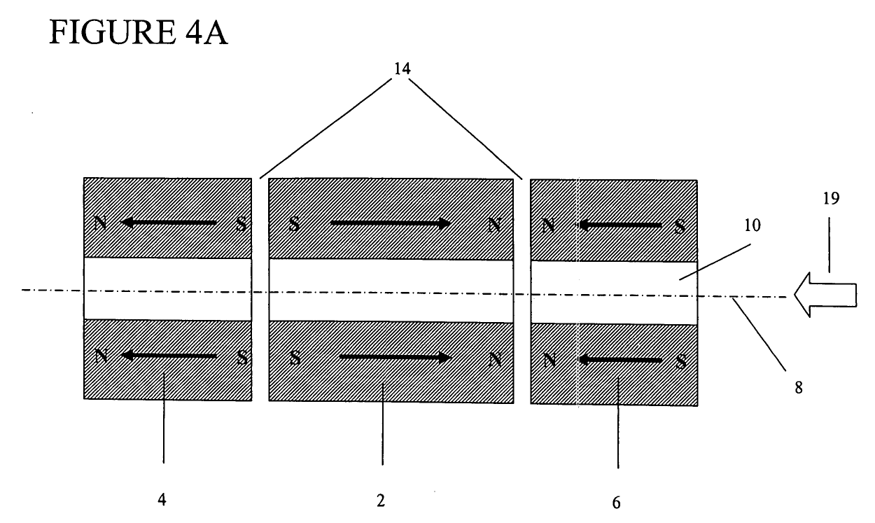

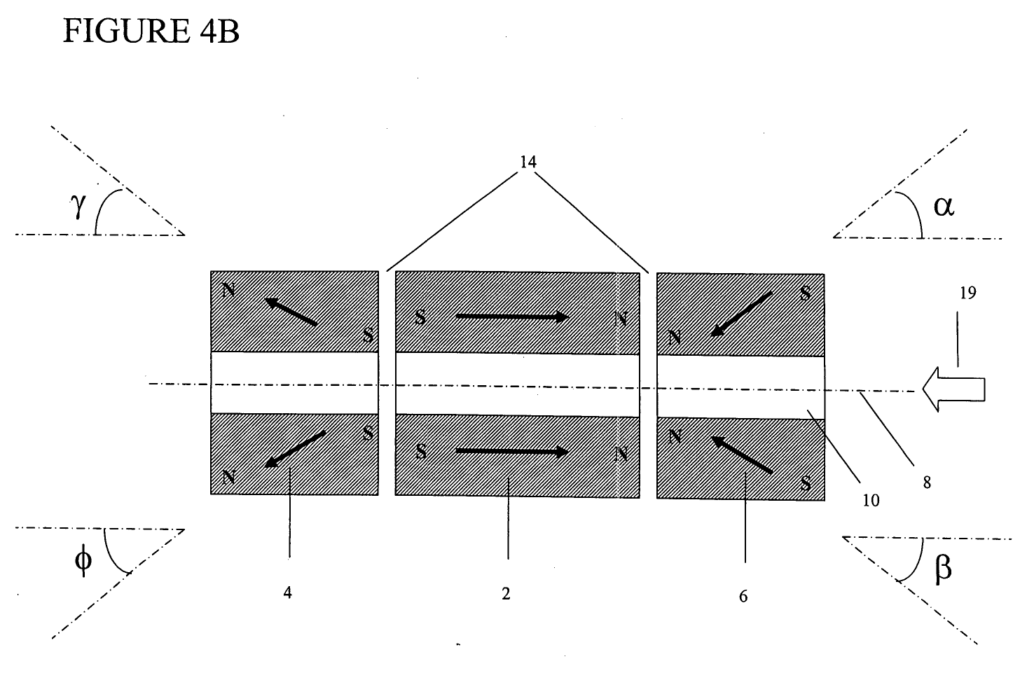

FIG. 4A is a schematic depicting one configuration of the present invention having alternating directions of magnetization of the magnetic materials inside the hollow body flux sources of the present invention. FIG. 4B is a schematic depicting another configuration of the present invention for the direction of magnetization inside the hollow body flux sources of the present invention. As schematically represented in FIGS. 4A and 4B, the resultant magnetic fields in the adjacent hollow body sources 4 and 6 are directed either along the common axis 8 of the respective through-holes 10, or at an angle to the common axis 8 of the respective through-holes 10. In the latter case, the direction of the magnetic field has a radial component and possesses cylindrical symmetry. The magnetic fields in the adjacent hollow body sources 4 and 6 are generally dipolar in character. The polarities of the magnetic field generated by the central hollow body source 2 at the respective ends of central hollow body source 2 along the axis are opposite to the polarities of the magnetic fields generated by adjacent hollow body sources 4 and 6 at the respective ends adjacent to the central hollow body source 2 along the common axis 8.

In this configuration, the permanent magnet exhibits a higher flux density in the center of the through-hole 10 of the central hollow body source 2 while minimizing the amount of magnetic material used, the size of the permanent magnet structure, and the weight of the permanent magnet structure by reducing the magnetic flux leakage and focusing the flux density lines into the working volume 18 of the central hollow body source 2. In one embodiment of the present invention, a plurality of permanent magnet segments are used including magnetic materials having a coercivity greater than 500 Oersteds. As illustrated, in FIG. 4B, the second and third flux sources (i.e., the non-central flux sources) can be configured to generate second and third dipolar magnetic fields directed at an angle between −90 and +90 degrees to the common axis.

In general, the magnetization direction inside magnetic flux sources adjacent the central magnetic flux source can be at any angle between being axially magnetized or magnetized perpendicular to the common axis 8. The present inventor has determined that, for the field strength in the central magnetic flux source 2, the perpendicular magnetization of the side magnetic flux sources 4 and 6 (when the vector of magnetization of all magnets comprising the source 4 is directed outward the common axis and the vector of magnetization of all magnets comprising the source 6 is directed toward the common axis) gives higher field strength inside the central source 2. However, perpendicular magnetization is not always possible for ring shape magnets, and some magnetic materials may not permit such a perpendicular direction of magnetization. In this case the ring shape magnets can be constructed of smaller parts having desired magnetization. The shape of smaller parts can be any ranging from rectangular pieces to arc segments. Regardless, the magnetization direction for the magnet structure of the present invention preferably reverses along the common axis, as shown in the figures. Suitable permanent magnetic materials for the present invention include, but are not limited to, Nd, Sm, NdFeB, SmCo, Alnico alloys, Ferrite (Ceramic) magnets, and other permanent magnet alloys. The magnetic materials utilized in each of the flux sources 2, 4, and 6 can be of different type. For example, central source 2 can be made of rare-earth magnetic materials, such as NdFeB and/or SmCo, while side flux sources 4 and 6 can be made of other permanent magnet alloys.

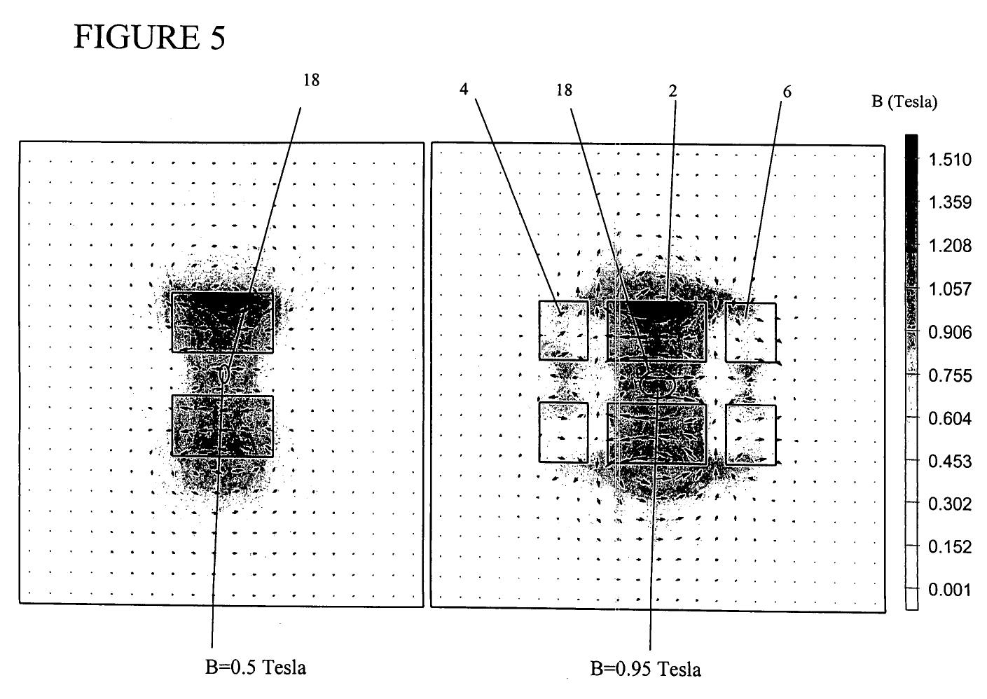

FIG. 5 shows results of calculations of the magnetic field fluxes generated by an embodiment of the magnet structure according to the present invention and the structure based on a single hollow cylinder containing magnetic materials magnetized to generate magnetic field flux along a common axis. Calculations were made for structures made of the same magnetic materials and having the same through-hole 10 and working volume 18 dimensions. The calculations show that the magnet structure of the present invention effectively focuses magnetic flux generated by the central hollow source 2 inside the working volume 18, and can result in almost a two-fold increase in magnetic field strength inside the working volume 18 of the central hollow body source 2. In addition, the region of homogeneous magnetic field generated by magnet structure of the present invention (which defines the extent of the practical working volume) is larger along the common axis by two-fold as compared to the single hollow cylinder. Further, the homogeneity of the magnetic field can be adjusted by varying the gaps 14 between the central hollow body flux source 2 and the adjacent hollow body flux sources 4 and 6.

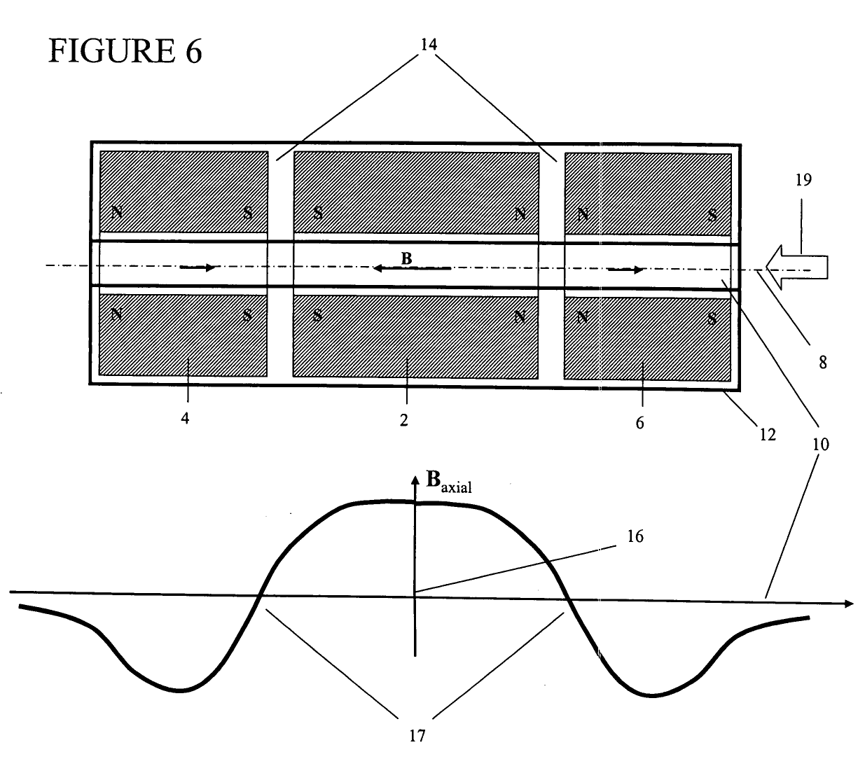

In general, the permanent magnet structure as described in FIGS. 1 and 4 creates a reversible magnetic field along the common axis 8 of the magnet structure such that a north pole (N) of the orientation of the magnetic flux in the central hollow body flux source 2 faces a north pole (N) of the orientation of magnetic flux generated by one of the adjacent hollow body flux sources 4 and 6 at the respective end of the central hollow body source along the common axis 8. Meanwhile, the south pole of the orientation of magnetic flux in the central hollow body flux source 2 faces a south pole of the orientation of magnetic flux generated by the other adjacent hollow body flux source at the respective end of the central hollow body source along the same common axis 8. Arranged in such a way, the adjacent hollow body flux sources 4 and 6 focus the magnetic flux inside the central hollow body flux source 2 and minimizes the magnetic flux leakage. Note, that the polarity of the magnetic field flux along the common axis 8 reverses along the common axis near the ends of the central hollow body source 2 as shown schematically in FIG. 6.

In one preferred embodiment of the present invention, the field as shown in FIG. 6 is symmetrical, but this requirement is not necessary for the present invention and other possible arrangements are suitable for the present invention. For example, the second magnet flux source 4 can include a through-hole body, while the third magnet flux source 6 may not have a through-hole body. In that situation, the magnetic field along the common axis will not be symmetrical. Further, different magnetic materials for the second and third sources can be used to produce a magnetic field along the common axis that is not symmetrical.

In general, it is desired that the magnetic dipole field in the place where ions are to be trapped and analyzed will not be reversed. In that region (e.g., the central region of the central hollow source 2), the field will be dipole, homogeneous, and directed axially, with the reversing points locate outside the central region along the common axis.

Any physical device such as vacuum chamber having an FTMS trap for charged particles, any type of particle detectors that require the use of coherent and uniform magnetic field, a probe of NMR and/or EPR detector, a sample subject to MRI imaging, as well as other devices not limited by above examples, can be placed inside the magnet structure of the present invention. As an example a preferred embodiment of the invention wherein a permanent magnet having the reversible magnetic field (RMF) design is used in an FTICR-MS, is shown in FIG. 7.

As shown in FIG. 7, a quadrupole rod and/or ion traps are inserted in the through-hole 10 along the common axis 8. Ions 19 generated in an ion source 22 (which can be, but is not limited to an ESI or atmospheric pressure MALDI source) from sample 21 (which can be either from the liquid chromatography column, or gas-chromatography column, or from other sampling sources) enter the vacuum system 23 and transit a skimmer 24 from which the ions pass through a first quadrupole rod 26 and then a second quadrupole rod 28. The vacuum system 23 consists of a number of sections connected to each other by openings in the section walls referred to as conductance limits and differentially pumped by vacuum pumps 29. Ions travel in the second quadrupole rod 28 along the magnetic field lines in the second flux source 4, and upon exiting the quadrupole rod 28 enter the central flux source 2 where FTMS trap 20 captures the ions. In this illustrative example, when an FTMS trap of charged particles is used as a mass analyzer, the charged particles are injected along the magnetic flux lines into the FTMS trap and, therefore along the common axis 8 of the magnet structure of the present invention. Moreover, particles can be introduced from external sources into the FTMS trap along the common axis 8 by different mechanisms of ion transport such as disclosed in J. A. Olivares, et al., Anal. Chem., 1987, 59, pp. 1230-1232; R. D. Smith, et al., Anal. Chem. 1988, 60, pp. 436-441; H. J. Xu, H. J., et al., Nucl. Instrum. Meth. Phys. Res., 1993, 333, pp. 274-282; U.S. Pat. Nos. 4,328,420; 4,535,235; 4,963,736; 5,572,035; 5,652,427; 6,107,628; 6,111,250; and U.S. Patent Application No. 20040211897, the entire contents of which are incorporated herein by reference. In FIG. 7 the charged particles (ions) are introduced into the ICR trap using a quadrupole ion guide. The dimensions of the trap are limited by the diameter of the through-holes of the hollow body sources.

Furthermore, other techniques for mass analysis and mass separation, known in the art, are suitable for the present invention. These techniques include but are not limited to for example a mass spectrometer of an ion cyclotron resonance, a mass spectrometer of an ion cyclotron resonance having a Fourier transform to generate mass spectra, a time-of-flight mass spectrometer, a quadrupole mass spectrometer, a radio-frequency ion trap mass spectrometer, and an ion mobility spectrometer, and other known mass spectrometry techniques utilizing homogeneous magnetic fields for mass isolation, fragmentation, separation, and analysis.

As such, the present invention in one embodiment includes a mechanism for trapping charged particles in at least one of a Penning type trap, a linear radio-frequency multipole trap, or a Paul type trap. In one embodiment, the present invention includes a mechanism for focusing charged particles inside at least one of a radio-frequency multipole ion guide and/or an electrostatic ion guide, a mechanism for storing charged particles for a prolonged time with subsequent isolation of at least part of the charged particles, and/or a mechanism for interactions of the charged particles with at least one of a laser beam, a neutral, or charged particle beam, an electron beam, or a background neutral molecule beam, or any combination thereof. In one embodiment, the present invention can include a mechanism for generating interactions between charged particles resulting in subsequent fragmentation of at least part of the charged particles. For example, the electron source 30 located within the magnet structure near the FTMS trap as shown in FIG. 7 can generate low energy (usually less than 1 eV) electrons 31 which interact with ions inside of the FTMS trap 20 to produce ion fragments via ECD mechanism.

The interaction mechanism of the present invention exemplified by the electron source 30 in FIG. 7 thus includes but is not limited to interactions, which result in fragmentation of the ions. Among techniques known in the art for fragmentation are Electron Capture Dissociation (ECD), where due to energy release, for example, ions capturing electrons dissociate, and Electron Transfer Dissociation (ETD) where ions of one polarity interact with the ions of other polarity and, within this interaction mechanism, an electron from negatively charged ion transfers to the positively charged ion and the latter dissociate. Laser and other particle beam interactions are also suitable in the present invention.

In general, the permanent magnet structure of the present invention can generate a homogeneous axial magnetic field with axial access to a central high magnetic field region for application in a variety of spectroscopic applications including but not limited to mass spectrometry (MS), nuclear magnetic resonance (NMR), electron paramagnetic resonance (EPR), and magnetic resonance imaging (MRI) spectroscopies. As such, the magnet structure of the present invention can produce inside the central flux source a unidirectional magnetic field for analyzing at least one of a mass-to-charge ratio of a charge particle, a frequency of orbiting of electrons in an atom, a frequency of an electron spinning, a frequency of spinning of an atomic nucleus, a magnetic moment of an atom or an atomic nucleus, an energy of an electron in an atom.

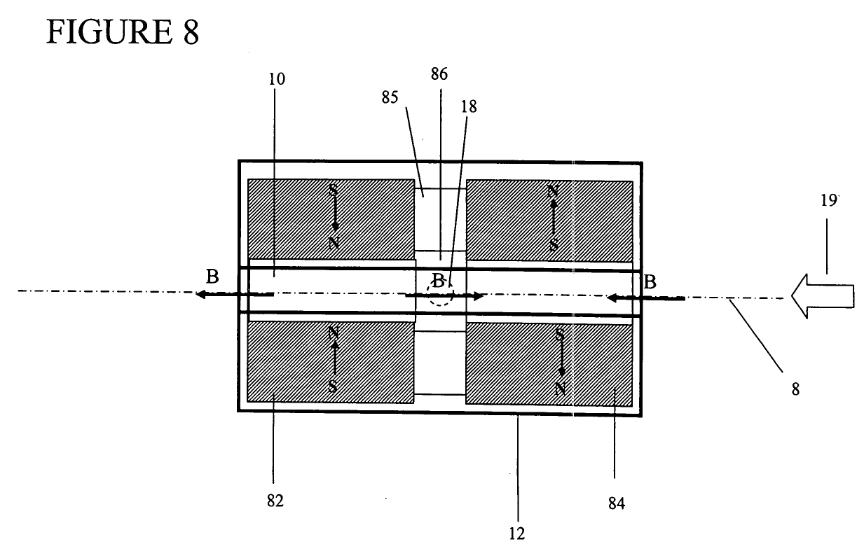

In another embodiment of the present invention, the magnet field arrangement shown in FIG. 5 can be realized with only two magnet flux sources, as shown in FIG. 8. In this embodiment, the central flux source 2 as shown in FIG. 1 is not necessary. Instead, the magnetic field is generated as shown in FIG. 8 by magnet flux sources 82 and 84 with the magnetic axial field existing in a gap between the magnet flux sources 82 and 84. The magnet flux sources 82 and 84 can be made and formed of the same materials and construction as described above for magnet flux sources 2, 4, and 6 and the other magnet flux sources. Magnet flux sources 82 and 84 will preferably have a direction of magnetization as described below. The resultant magnetic field will have a magnetic field component whose direction along the common axis is at least once reversed along the common axis within the magnet structure. For example, as shown in FIG. 8 for example, the resultant magnetic field near the left side of magnet flux source 82 has a field component that is directed along the common axis 8 to the left, while the resultant magnetic field in region 86 between the magnet flux sources 82 and 84 has a field component that is directed along the common axis 8 to the right, and the resultant magnetic field near the right side of magnet flux source 84 has a field component that is directed along the common axis 8 to the left.

In this embodiment, magnet flux sources 82 and 84 are preferably magnetized at an angle to the common axis 8 but the magnetization of one of the flux sources 82 and 84 is reversed relative to the magnetization of the other. For example, the angle to the common axis can be +90 degrees for magnet flux source 82 and −90 degrees for magnet flux source 84. As such, the magnet flux source 82 can be magnetized radially toward the common axis 8, while magnet flux source 84 can be magnetized radially away the common axis 8.

To maximize the axial field along the common axis 8, a gap region 86 between the magnet flux sources 82 and 84 is preferably minimized. The distance of the gap region 86 will determine the field strength, working volume 18, and homogeneity, meaning that there is an optimal gap for specific applications. For example, the gap can be adjusted to obtain the strongest magnetic field in the center or the field having maximum homogeneity in the central area. The latter is pertinent to Fourier transform mass spectrometry. Setting the gap 86 between magnet flux sources 82 and 84 can be performed using the housings and threaded rods discussed above for FIGS. 2B-2D.

In one embodiment of the present invention, there can be no gap between the magnet flux sources 82 and 84. In such a case, the magnetic field in the working volume 18 will be maximal although the homogeneous region of this field in the working volume 18 will be minimal. In a gap region between the magnet flux sources 82 and 84, there can be a hollow body insert 85 made of non-magnetic material, for example, aluminum or copper. Having such a non-magnetic body provides a mechanism for attaching the magnet flux sources 82 and 84 together and stabilizing the separation distance between the magnet flux sources 82 and 84. Having a non-magnetic body 85 between the magnet flux sources 82 and 84 also permits one to access to the working volume 18 by, for example, by radial holes in the non-magnetic body.

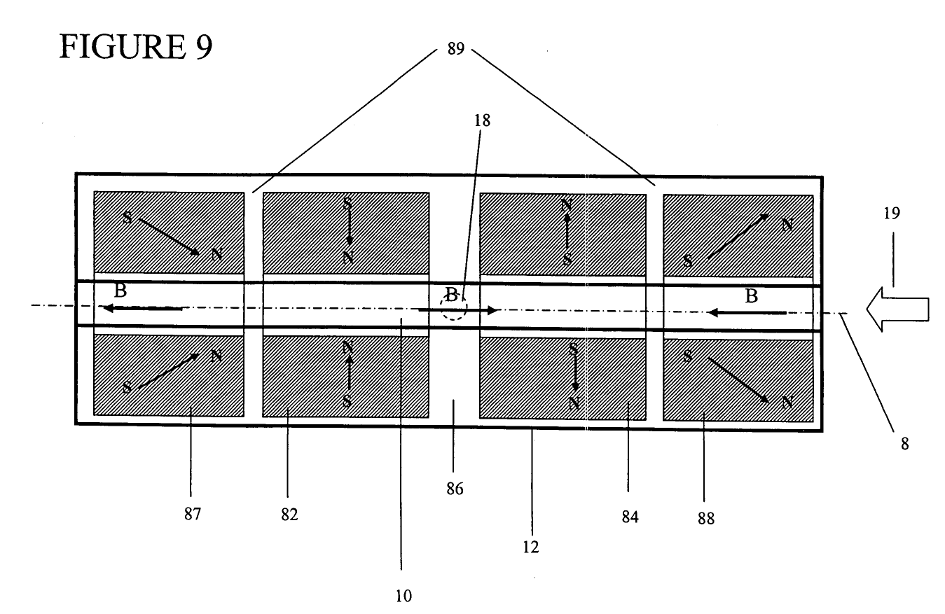

In another embodiment of the present invention, additional two magnet flux sources 87 and 88 can be placed along the same common axis 8 adjacent with the magnet flux sources 82 and 84 as shown in FIG. 9. The magnet flux sources 87 and 88 can increase the magnetic field flux in a gap region 86 between the magnet flux sources 82 and 84 by generating a reversible magnetic field along the common axis in the regions between magnet flux sources 82 and 87 and 84 and 88, respectively. This can be achieved by magnetizing the magnet flux source 87 in such a way that the generated magnetic field has a component along the common axis 8 of opposite direction relative to the field generated by magnet flux source 82 along the common axis 8. Accordingly, the magnet flux source 88 can be magnetized in such a way that the generated magnetic field has a component along the common axis 8 of opposite direction relative to the field generated by magnet flux source 84 along the common axis 8. In general, the magnetization direction for the magnet flux sources 87 and 88 can be at the angle to the common axis and that angle can be varied between 0 and 90 degrees.

Magnetized as described, the magnet flux sources 87 and 88 can further push the magnetic fluxes generated by magnet flux sources 82 and 84 toward the central region 18 between the magnet flux sources 82 and 84 and along the common axis, thus increasing the axial field in the working volume 18. A gap 89 between the magnet flux sources 87 and 82 and 88 and 84, respectively, can be varied for the purpose of adjusting the magnetic field homogeneity and the volume of the homogeneous magnetic field in the central ion trap region 18. Setting the gap 89 between for example the magnet flux sources 84 and 88 can be performed using the housings and threaded rods discussed above for FIGS. 2B-2D.

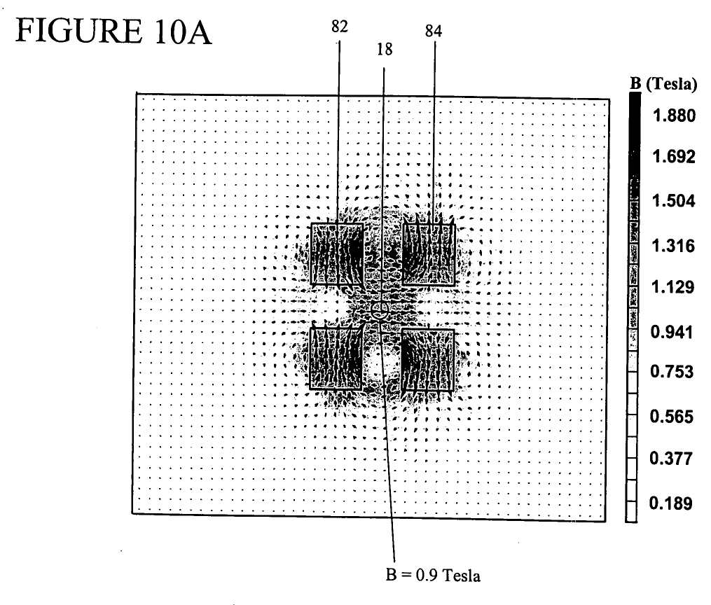

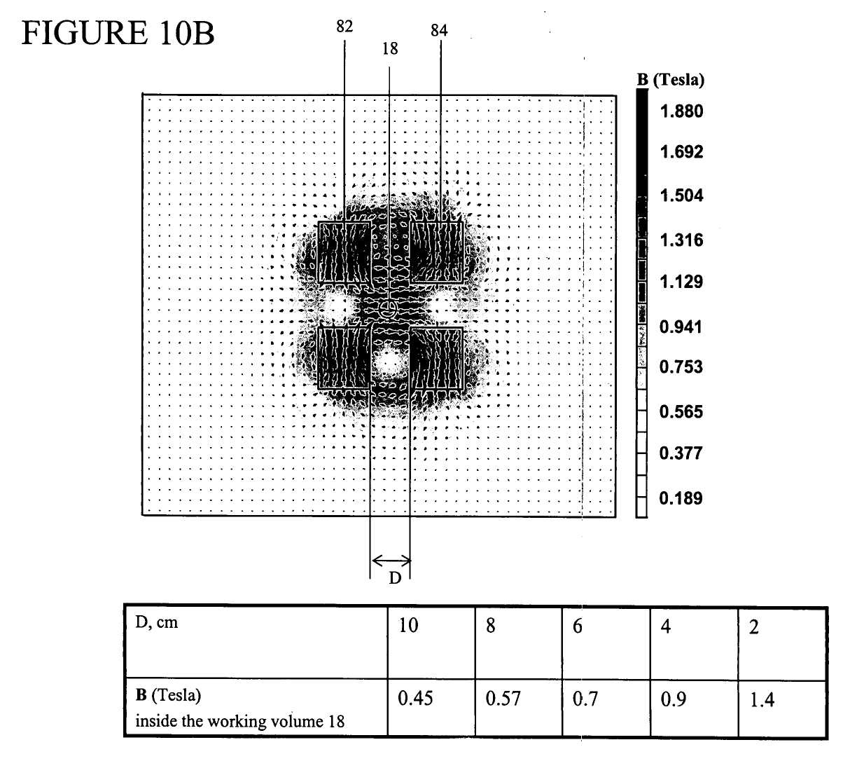

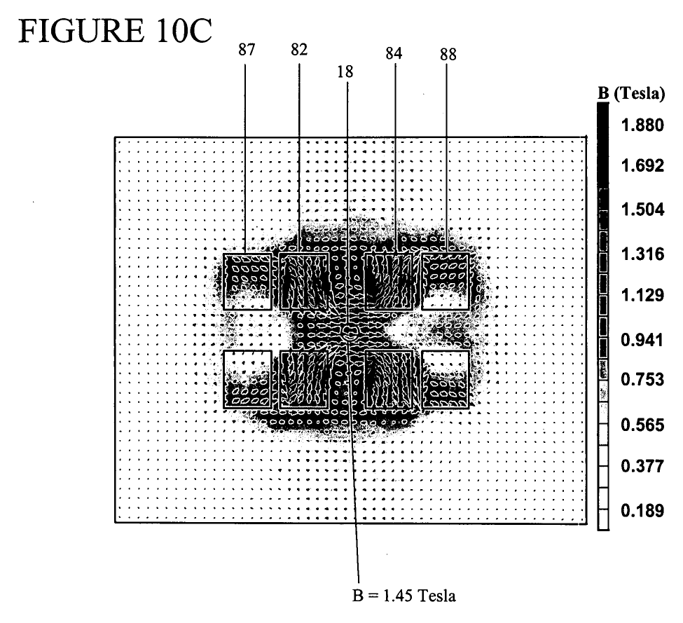

FIG. 10A shows a result of magnetic field calculations that demonstrates the feasibility of the magnet flux sources 82 and 84 to produce an axial magnetic field (similar to that in FIG. 5) along the common axis 8 that reverses it direction at least once along the common axis to produce within the gap region 86 (i.e., within a central region of the plurality of magnet flux sources 82 and 84) a uniform magnetic field. The calculations simulate a NdFeB material with a remanence flux density Bᵣ=1.2 Tesla and coercive force H_{CB}=899 A/m. Two identical hollow cylindrical magnets with ID=5.9 cm, OD=16 cm, and length L=5 cm located at the gap 86 distance D=4 cm have been simulated as the magnet flux sources 82 and 84. The magnetization of the left magnet flux source 82 is at +90 degrees toward the common axis 8 and that for the right magnet flux source 84 is −90 degrees outward the common axis 8. These calculations demonstrate that the axial magnetic field of 0.9 Tesla in strength can be generated in the central region 18 between the magnet flux sources 82 and 84 for such a configuration.

The results presented in FIG. 10B show that the resultant magnetic field in the working volume 18 in the center between the magnet flux sources 82 and 84 increases when the separation distance decreases. As summarized on FIG. 10B and as shown for illustrative purposes, a separation distance D of 10 cm can produce a field strength of 0.45 Tesla, while a separation distance of 8 cm can produce a field strength of 0.57 Tesla, a separation distance of 6 cm can produce a field strength of 0.70 Tesla, a separation distance of 4 cm can produce a field strength of 0.90 Tesla, and a separation distance of 2 cm can produce a field strength of 1.4 Tesla.

FIG. 10C shows the result of magnetic field calculations for the plurality of four magnet flux sources 82, 84, 87, and 88 that produces an axial magnetic field along the common axis 8 in the central gap region 86 and that generates a reversible magnetic field along the common axis 8 which increases the magnetic field strength and the working volume 18 of homogeneous magnetic field in the central gap region 86. The calculations simulate a NdFeB material with a remanence flux density Bᵣ=1.2 Tesla and coercive force H_{CB}=899 A/m. Four identical hollow cylindrical magnets with ID=5.9 cm, OD=16 cm, and length L=5 cm were simulated as magnet flux sources 82, 84, 87, and 88. Two central magnet flux sources 82 and 84 were located at the distance D=4 cm for a gap region 86, and two adjacent magnet flux sources 87 and 88 were located at the distances d=1 cm for gap regions 89. The magnetization of the magnet flux source 82 is at +90 degrees toward the common axis 8 and that for the magnet flux source 84 is −90 degrees outward the common axis 8. For this exemplary configuration, the magnetization of the magnet flux source 87 adjacent to the magnet flux source 82 is at +45 degrees toward the common axis 8 and that for the magnet flux source 88 adjacent to the magnet flux source 84 is −45 degrees outward the common axis 8. These calculations demonstrate that the axial magnetic field of 1.45 Tesla in strength can be generated in the central region 18 between the magnet flux sources 82 and 84 for such a plurality of flux sources. FIG. 10C typifies an illustrative embodiment in which a plurality of four hollow body magnet flux sources are magnetized in such a way as to generate a reversible magnetic field profile along the common axis 8 that produces a strong axial magnetic field in a larger volume as compared with a configuration consisting of only two magnet flux sources 82 and 84.

While the invention has been shown and described with reference to select embodiments thereof, it will be recognized that various changes in form and detail may be made herein without departing from the spirit and scope of the invention as defined by the appended claims. Indeed, the above-described embodiments are illustrative, and numerous additional modifications and variations are possible in light of the above teachings. For example, elements and/or features of different illustrative and exemplary embodiments herein may be combined with each other and/or substituted for each other within the scope of this disclosure and appended claims. It is therefore to be understood that within the scope of the appended claims, the disclosure of this patent specification may be practiced otherwise than as specifically described herein

1. A mass spectrometer with a magnet structure, comprising:
a plurality of magnetic flux sources disposed along a common axis including at least one permanent magnet flux source having at least one through-hole body along the common axis;
said plurality of magnetic flux sources generating a resultant magnetic field; and
a direction of a magnetic field component of the resultant magnetic field along said common axis at least once reversing along said common axis within the magnet structure.

2. The spectrometer of claim 1 wherein:
said plurality comprises first and second permanent magnet flux sources including said at least one through-hole body, and
said first and second permanent magnet flux sources have respective first and second magnetizations to generate first and second magnetic fields.

3. The spectrometer of claim 2, wherein the through-hole body comprises a through-hole directed along said common axis in which said magnetic fields permeate.

4. The spectrometer of claim 3, wherein the through-hole comprises a cylindrical, square, or elliptic bore.

5. The spectrometer of claim 2, wherein the first and second magnet flux sources have said first and second magnetizations directed at angles between −90 and +90 degrees to the common axis.

6. The spectrometer of claim 5, wherein said angles for said first and second magnetizations are fixed at −90 and +90 degrees, respectively.

7. The spectrometer of claim 2, wherein both the first and second flux sources include said through-hole body.

8. The spectrometer of claim 1, wherein at least one of the plurality of magnetic flux sources comprises:
a plurality of permanent magnet segments including magnetic materials having a coercivity greater than 500 Oersteds.

9. The spectrometer of claim 2, wherein the first and second flux sources are disposed adjacent to each other.

10. The spectrometer of claim 3, wherein the first flux source is configured to be spaced apart from the second flux source by an adjustable distance permitting magnetic field adjustment within said through-hole.

11. The spectrometer of claim 10, wherein the first flux source is configured to be spaced apart from the second flux source by a distance no greater than twice a diameter of said through-hole.

12. The spectrometer of claim 2, further comprising:
a non-magnetic body disposed between the first flux source and the second flux.

13. The spectrometer of claim 12, wherein the non-magnetic body forms a spacer setting the distance between the first flux source and the second flux.

14. The spectrometer of claim 2, wherein the first flux source and the second flux sources are configured to produce a symmetrical magnetic field along said common axis relative to a central point of the plurality of magnetic flux sources.

15. The spectrometer of claim 2, further comprising:
a housing for any of the plurality of magnetic flux sources; and
an array of magnetic materials arranged inside the housing to form any one of said first and second magnetic fields.

16. The spectrometer of claim 15, wherein said array is one of a linear array and a polar array, or a combination of those.

17. The spectrometer of claim 15, wherein the housing comprises:
plural housing units containing respectively magnetic materials of the permanent magnet segments for the first and second magnet flux sources and assembled into separated units.

18. The spectrometer of claim 17, further comprising:
a spacing mechanism configured to adjust a distance between the plural housing units.

19. The spectrometer of claim 17, further comprising:
a non-magnetic body disposed between the plural housing units.

20. The spectrometer of claim 19, wherein the non-magnetic body forms a spacer setting the distance between the plural housing units.

21. The spectrometer of claims 1 or 2, further comprising at least one of:
means for trapping charged particles in at least one of a Penning type trap, a linear radio-frequency multipole trap, or a Paul type trap;
means for focusing charged particles inside at least one of a radio-frequency multipole ion guide and an electrostatic ion guide;
means for storing charged particles for prolong time with subsequent isolation of at least part of said charged particles, or for interactions of said charged particles with at least one of introduced laser beams, neutral, or charged particle beams, electron beams, or background neutral molecules, or any combination of said interactions; and
means for generating interactions between charged particles resulting in subsequent fragmentation of at least part of said charged particles,
wherein the magnet structure is a part of at least one of said means for trapping, means for focusing, means for storing, and means for generating.

22. The spectrometer of claim 2, further comprising:
third and fourth permanent magnet flux sources including said at least one through-hole body, and
said third and fourth permanent magnet flux sources disposed outside of said first and second permanent magnet flux sources, and having third and fourth magnetizations that increase the first and second magnetic fields.

23. The spectrometer of claim 2, wherein:
the first magnetization of the first magnet flux source is radially toward the common axis, and
the second magnetization of the second magnet flux source is radially away from the common axis.

24. A magnet structure for spectroscopy comprising:
a plurality of magnetic flux sources disposed along a common axis including at least one permanent magnet flux source having at least one through-hole body along the common axis;
said plurality of magnetic flux sources generating a resultant magnetic field; and
a direction of a magnetic field component of the resultant magnetic field along said common axis is at least once reversed along said common axis within the magnet structure.
